(19) United States
(12) Patent Application Publication
(10) Pub. No.: US 2017/0215635 A1
(43) Pub. Date: Aug. 3, 2017

(54) Wok Device for Support, Heat Enhancement, and the Rapid Lighting of Solid Fuel

(71) Applicant: Raymond Palermo, Marietta, GA (US)

(72) Inventor: Raymond Palermo, Marietta, GA (US)

(21) Appl. No.: 15/421,723

(22) Filed: Feb. 1, 2017

Related U.S. Application Data
(60) Provisional application No. 62/388,569, filed on Feb. 2, 2016.

(51) Int. Cl. A47J 36/00; F24B 15/00; F24B 13/02

(52) U.S. Cl. CPC A47J 36/00; F24B 13/02; F24B 15/00

(57) ABSTRACT

An outdoor cooking device preferably constructed from sheet metal or other non-combustible material comprising a wok support tube and a circular disk to act as a heat shield attached to the support tube. The support tube contains vent holes or relief cuts above the heat shield. The outer diameter of the disk fits just inside the inner diameter of an outdoor cooker. The support tube allows a wok or similar cook pan to sit proud of the outer cooker walls. This arrangement channels hot air and fire from a heat source, typically charcoal contained within the device tube, to the surface of a wok to provide true high heat wok cooking.

### CROSS REFERENCE TO RELATED APPLICATIONS

This application claims the benefit of provisional patent application Ser. No. 62/388,569, filed 2016 Feb. 2 by the present inventor.

### FEDERALLY SPONSORED RESEARCH

None

### BACKGROUND

Cylindrical or concave outdoor cooking devices are now commonplace. U.S. Pat No. 7,644,711 to Creel (2010), shows one patent on what is commonly known as The Big Green Egg™. This cooker has a cylindrical body with a concave bottom. This cooker is good for preparing many dishes but the shape is not conducive to using a wok.

U.S. Pat No. 5,158,067 to Dutro (1992) is one of many patents that demonstrate the need for supporting a wok on an outdoor cook stove. Neither this patent nor U.S. Pat No. 7,661,421 to Lustig (2010) and U.S. Pat No. 7,694,671 to Lee (2010) solve the problem of supporting a wok above the outer walls of today's modern cook stoves due to their low height. Previous iterations do not concentrate the heat in a small area on the wok pan bottom nor do they amplify temperatures.

### SUMMARY OF THE INVENTION

The present disclosure presents various embodiments, features, aspects, functions, characteristics, etc. of a device used to support, amplify heat, and evenly distribute heat from an outdoor cook stove to a wok pan or a similar concave cooking vessel, pot, pan or device.

Further features, advantages, characteristics, aspects, etc., that can be incorporated into various embodiments of the versatile cooker are presented in more detail in the following description, with reference being made to the various drawings.

### DRAWINGS

Figure Numerals:

FIG. 1 is an isometric view of a wok support device in accordance with one embodiment.

FIG. 2 is a cross-section view of a wok support device in accordance with one embodiment.

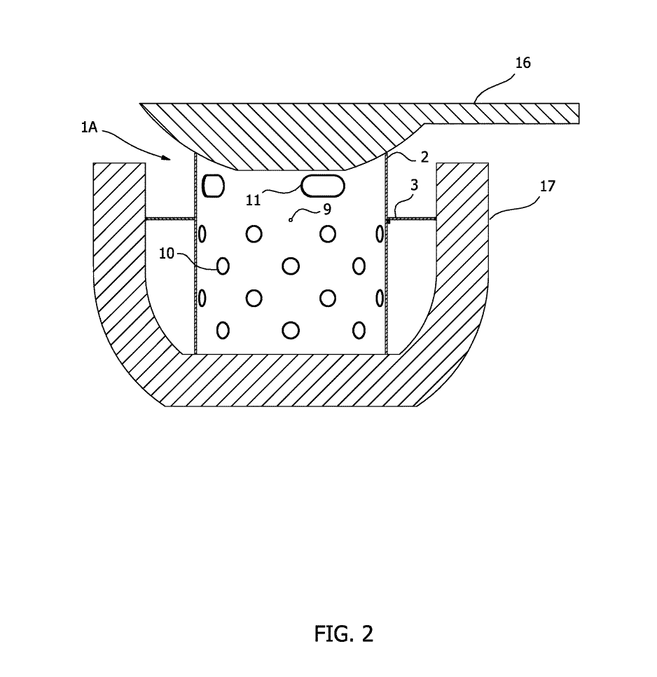

FIG. 3 is an exploded view of a wok support device in accordance with one embodiment.

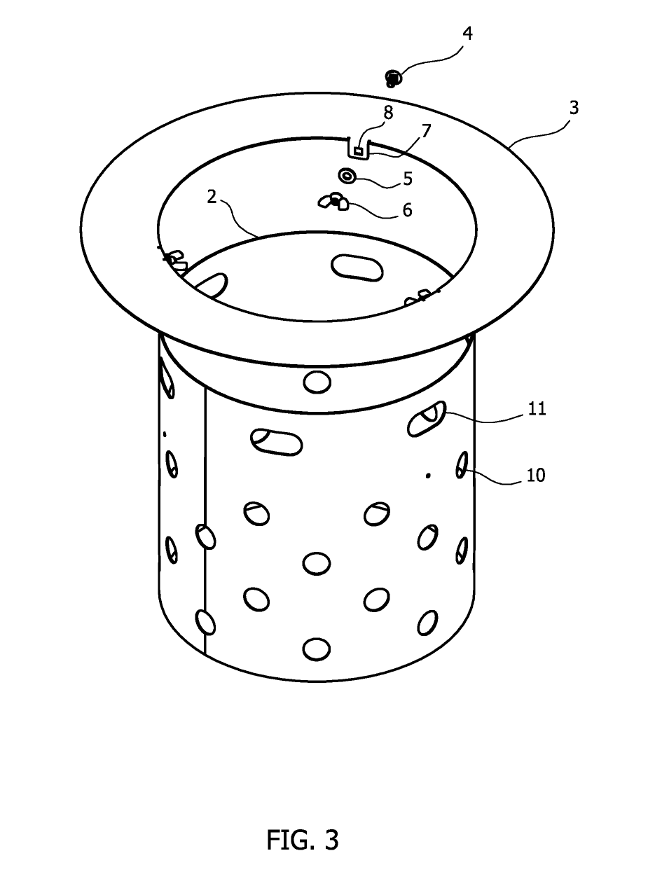

FIG. 4 is an enlarged exploded view of a wok support device showing one fastening system in accordance with one embodiment.

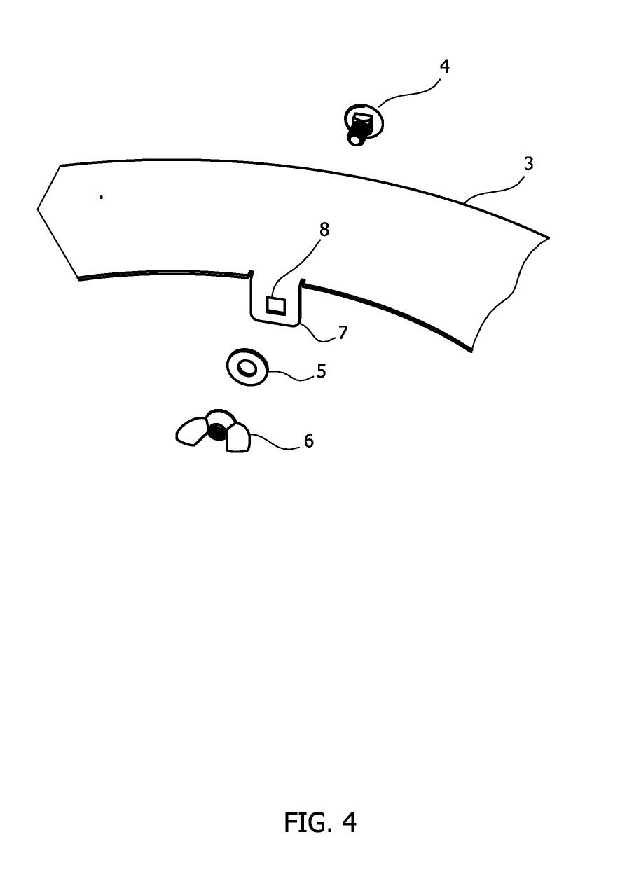

FIG. 5 is an alternate embodiment of a wok support device having handle holes to aid in placing the device into the cooker.

FIG. 6 is a side view of an alternate embodiment of a wok support device showing another of the many possible geometries of vent holes to improve combustion.

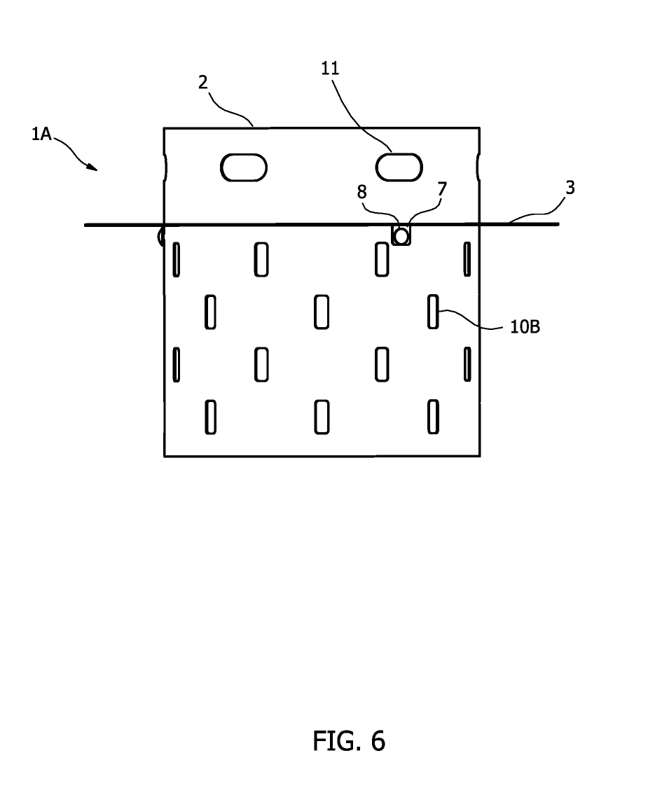

FIG. 7 is an isometric view of an alternate embodiment of the present invention showing no holes below the heat shield flange and scalloped cuts in the upper cylindrical member.

FIG. 8 is a cross-sectional view of an alternate embodiment of the present invention showing no holes below the heat shield flange and scalloped cuts in the upper cylindrical member.

FIG. 9 is a front elevation view an alternate embodiment of the present invention showing no holes below the heat shield flange and scalloped cuts in the upper cylindrical member.

FIG. 10 is a front elevation view of an alternate embodiment of the present invention showing scalloped cuts of variable size.

REFERENCE NUMERALS

| | | | |
|---|---|---|---|
| 1 | wok device | 2 | support tube |
| 3 | heat shield | 4 | carriage bolt |
| 5 | washer | 6 | clamping nut |
| 7 | mounting tabs | 8 | mounting hole |
| 9 | rivet | 10 | circular vent holes |
| 11 | oblong vent holes | 12 | upper vent holes |
| 13 | handle holes | 14 | scalloped cuts |
| 15 | top of scallops | 16 | wok |
| 17 | cooker | 18 | charcoal |
| 19 | shallow cuts | 20 | deep cuts |

### DETAILED DESCRIPTION

The wok device (1A) is comprised of two metal pieces. The support tube (2A) and the heat shield (3A). The support tube (2A) and heat shield (3A) are either welded to one another or held in place with fasteners, such a carriage bolt (4), washer (5), and clamping nut (6). If a carriage bolt (4) is used, the heat shield (3A) preferably has a corresponding number of mounting tabs (7) incorporated into it with a mounting hole (8) being square for a carriage bolt (4) or a standard bolt or rivet (9).

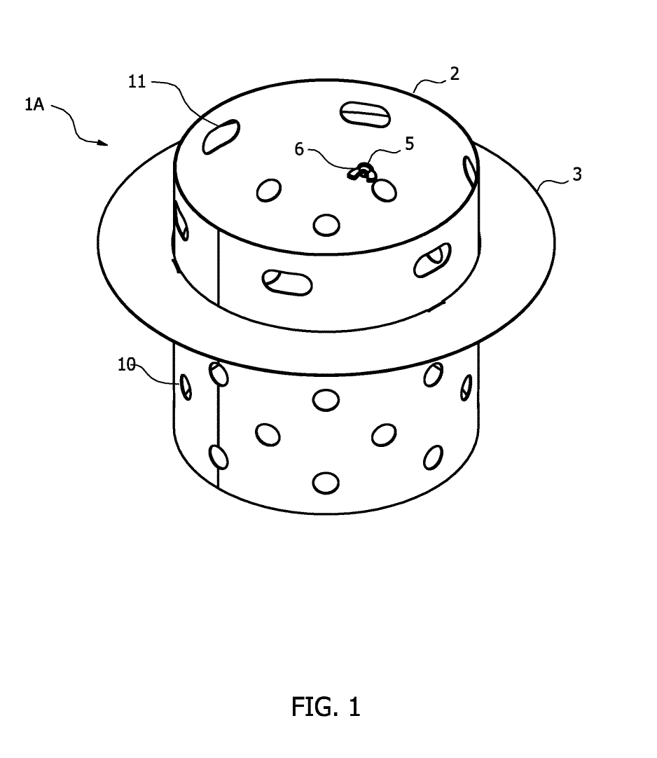

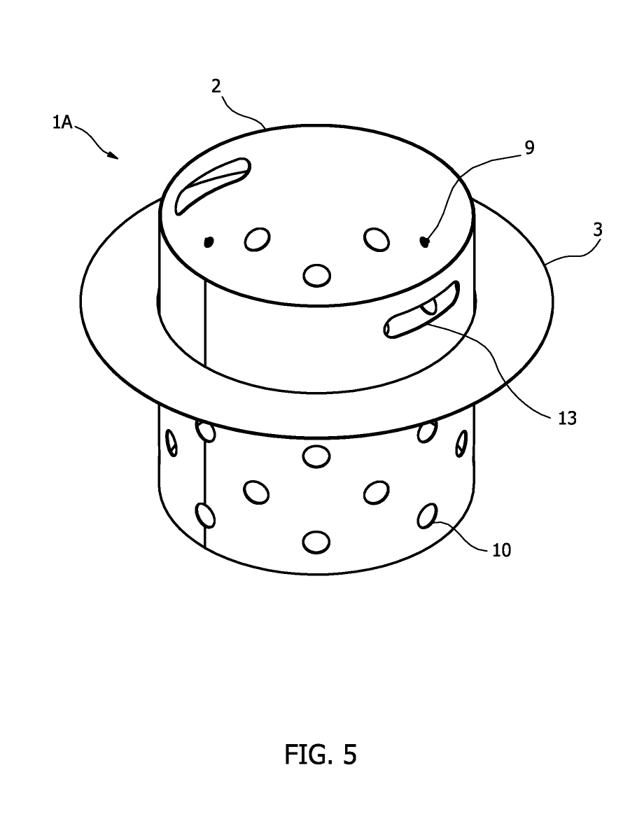

Circular vent holes (10) as shown in FIG. 1 or oblong vent holes (11) as shown in FIG. 5 could be used to aid in combustion. Additionally, upper vent holes (12) or handle holes (13) would be required to keep from extinguishing the fire.

If the support tube (2) and heat shield (3) are shipped separate, assembly would be required. The fasteners would be used to secure the metal to the support tube shape as well as to hole the heat shield (3) in place.

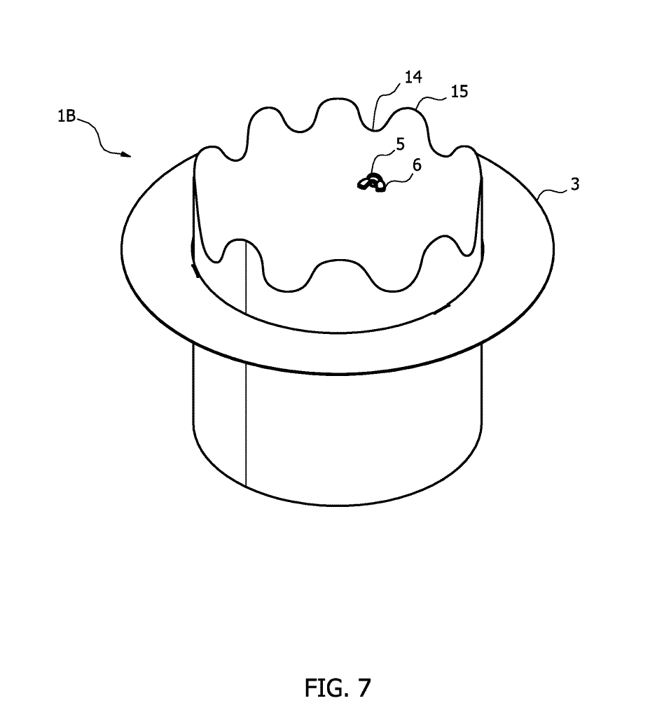

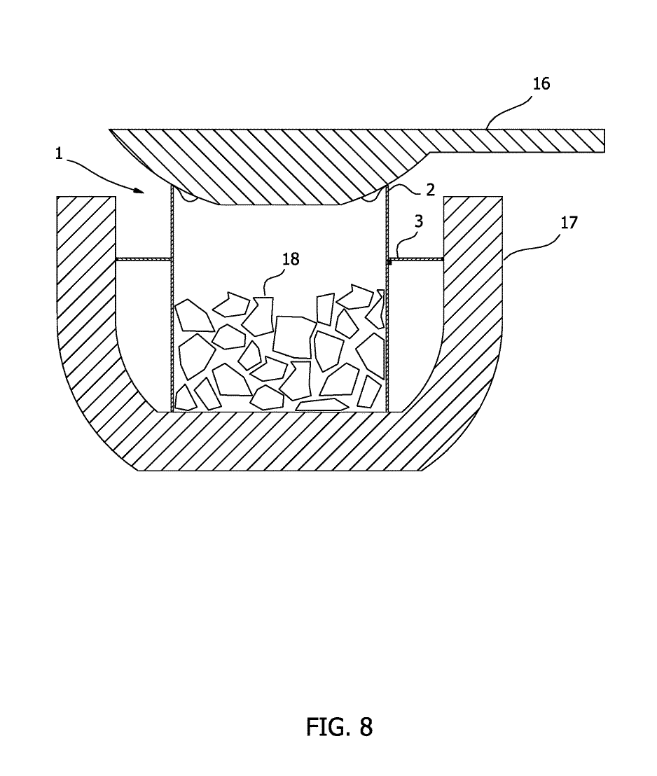

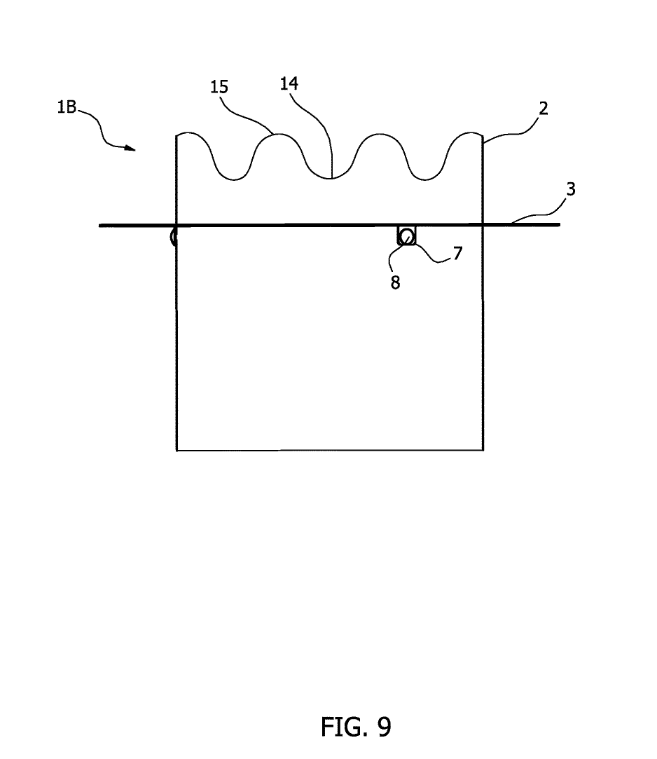

An alternate embodiment of a wok support device (1B) is shown in FIG. 7-9. No vent holes are located in the support tube (2B) below the heat shield (3B). Scalloped cuts (14) allow fire and hot air to escape from the openings while the top of the scalloped cuts (15) support a wok (16).

### Operation

The wok support device (1B) is typically inserted in the cooker (17) first. Charcoal (18) is added to the inside of the support tube (2). The charcoal (18) is ignited. When the charcoal (18) is sufficiently hot, the wok (16) is placed on top of the support tube (2) to be higher than the top of the cooker (17) side wall to accommodate the and use the pan as well as place and remove the pan easily. The support tube (2) both contains the fire as well as amplifies the fire and heat to provide true high heat wok cooking. Hot air and fire moves up the support tube (2B) and exits through the scalloped cuts (14) preferably following the contour of the wok (16). The heat shield (3B) prevents excess heat from reaching the handle of the wok (16) as well as requiring aspiration for the fire to move through the tube and fuel. The heat shield (3B) may be made in multiple pieces to maximize material usage when cut from a sheet of metal on a laser cutter or the like.

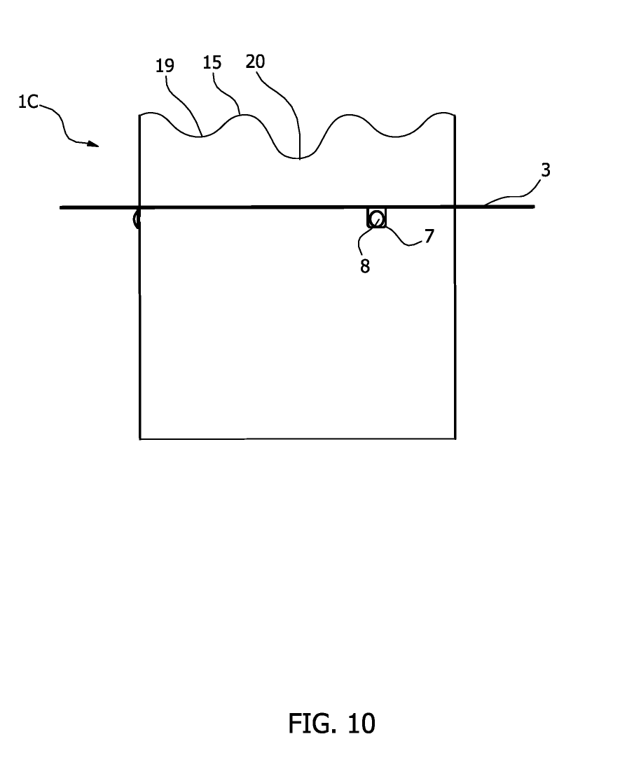

FIG. 10 shows another embodiment of the wok support device (1C). Shallow (19) and deep scallops (20) may be used to create a different heat profile around the outer surface of the wok (16). Alternatively, these scalloped cuts (14) may be square or rectangular in shape to increase the surface contact between the support tube (2) and the wok (16). Similarly, the top of the scallops (15) may be flattened in shape to increase the surface contact.

1. An outdoor cooking device comprising:
a. a non-combustible support tube having a plurality of relief cuts at its upper edge,
b. a heat shield fixably mounted below said relief cuts to the outer diameter of said support tube with the inner diameter for receiving said support tube and an outer diameter less than the inner diameter of a cook stove,
whereby charcoal is burned or a heat source is used within said support tube and a wok or related cooking utensil is placed on the top of said support tube for outdoor cooking.

2. The support tube of claim 1 further comprising a plurality of vent holes below said heat shield to support combustion within said support tube.

3. The relief cuts of claim 1 having scalloped shapes to allow for less turbulent flow of hot air during cooking.

4. The support tube of claim 1 further comprising a plurality of oblong handle holes above said heat shield to aid in placement and repositioning of said cooking device.
